(19) United States
(12) Patent Application Publication
(10) Pub. No.: US 2015/0189070 A1
(43) Pub. Date: Jul. 2, 2015

(54) MOBILE PLATFORM FUNCTIONALITIES EMPLOYING PROXIMAL VARIANTS AND ADVANCED PERSONALIZATION METHODS TO CONTROL DYNAMIC ICON DISPLAY ON A MOBILE COMPUTING DEVICE DISPLAY SCREEN

(71) Applicant: Richard L. Baker, Lexington, KY (US)

(72) Inventor: Richard L. Baker, Lexington, KY (US)

(21) Appl. No.: 14/579,637

(22) Filed: Dec. 22, 2014

Related U.S. Application Data
(60) Provisional application No. 61/918,769, filed on Dec. 20, 2013.

(51) Int. Cl. H04M 1/725; G06F 17/30; G06F 3/0482; H04L 29/08; G06F 3/0481

(52) U.S. Cl. CPC H04M 1/72572; H04L 67/10; G06F 3/04817; G06F 3/0482; G06F 17/30876

(57) ABSTRACT

A method for displaying information on a mobile computing device display screen includes communicating a mobile computing device unique identifier to a remote computing system. The remote computing system detects at least proximity of the mobile device to a first geographical location and determines a most relevant content according to the unique identifier and detected proximity. The remote system transmits a first icon operatively connected to the determined most relevant content to the mobile computing device, which automatically displays the first icon on a predetermined position of the mobile computing device display screen. As a user of the mobile device moves to a second location, the process is repeated to identify a second icon operatively connected to a most relevant content according to the device unique identifier and the next location. The second icon automatically replaces the first icon on the predetermined position of the display screen.

This application claims the benefit of U.S. Provisional Patent Application Ser. No. 61/918,769 filed on Dec. 20, 2013, the disclosure of which is incorporated herein by reference in its entirety.

### TECHNICAL FIELD OF THE INVENTION

Generally, the present invention relates to computing devices and environments involving mobile computing devices. Particularly, although not exclusively, it relates to methods for controlling information display on a mobile computing device display screen using measures of user proximity and relevance. Other embodiments contemplate computing systems and computer program products, to name a few.

### BACKGROUND OF THE INVENTION

On the web, search engines simplify locating millions of websites and aps. Many websites dynamically customize the home screen of a particular user based on the characteristics (interests, social category, context, etc.) of an individual. This type of personalization is founded upon the premise that these changes are based on implicit data, such as items purchased or pages viewed. The term customization is used instead when the site only uses explicit data such as ratings or preferences.

Three essential categories of personalization are known:

1. Profile/Group based

2. Behavior based (also known as Wisdom of the Crowds)

3. Collaboration based

Web personalization models include rules-based filtering, or “if-then” statements, based on “if this, then that” rules processing, and collaborative filtering, which serves relevant material to customers by combining their own personal preferences with the preferences of like-minded others.

Three broadly used methods of web personalization are known:

1. Implicit

2. Explicit

3. Hybrid

With implicit personalization the personalization is performed by the web page (or information system) based on the different categories mentioned above. With explicit personalization, the web page (or information system) is changed by the user using the features provided by the system. Hybrid personalization combines the above two approaches to leverage the best of both worlds. Many companies offer services for web recommendation and email recommendation that are based on personalization or anonymously collected user behaviors.

In statistics, Bayesian inference (or probability) is a method of inference in which Bayes Rule is used to update the probability estimate for a hypothesis as additional evidence is acquired. Bayesian updating is an important technique throughout statistics, and especially in mathematical statistics. For some cases, exhibiting a Bayesian derivation for a statistical method automatically ensures that the method works as well as any competing method.

Such personalization would be useful in the context of portable computing devices. However, such devices present unique problems of storage capacity and available area to display information.

Portable communication devices, which as is known are mobile computing devices, are typically capable of supporting wireless communication. Typical examples of portable communication devices include, although are not limited to, mobile telephones, cellular phones, wireless-enabled tablet computers, “smart” phones, laptop computing devices, personal digital assistants (“PDA's”) and other such similar devices. Currently, portable communication devices including smart phones utilize a wide variety of different operating systems depending on the manufacturer to execute different functions. Most of these devices have the ability to determine proximity, either via GPS, or the more recently released BLUETOOTH Low Energy (BLE) technologies. A major predominant problem on all mobile devices is the explosion in the number of apps available on various operating systems and platforms, and conversely, the very limited space available on the home screens of small and medium sized mobile devices. As previously stated, there are millions of apps and only a few inches of viable screen real estate upon which to display them. Even if the real estate were infinite, the user would encounter great difficulties locating apps visually on this extended screen real estate. The more apps installed on a particular device, the more difficult it is to find the app a user is looking for. The current solutions are, to display sets of scrolling home screens with a large number of apps on each screen, or to place apps related to a particular heading into a folder. But this is not a long term solution to the problem.

Therefore, for mobile devices a need exists in the art for better methods for searching and display of information. The need further extends to at least methods for storage management, in view of the often more limited storage capacity of mobile computing devices. Any improvements along such lines should also contemplate good engineering practices, such as simplicity, ease of implementation, unobtrusiveness, stability, etc.

### SUMMARY OF THE INVENTION

By applying the principles and teachings described herein, the foregoing and other problems become solved. Using the described methods and systems, in the small amount of display screen real estate available to a mobile computing device—for example, the area of a single app icon—many dozens, or even thousands of apps, can be more easily accessed by a user; firstly, based on proximity, but additionally, via settings, preferences and predictive algorithms analyzing user patterns designed to make the icon of the app rotated into the active icon position (referred to in this application as the DIDA or Dynamic Icon Display Application icon position), the most useful to a particular user, in a particular location, at a particular time. The DIDA icon is like a chameleon. It changes wherever the user goes based on location and other factors.

Broadly, systems and methods for dynamically changing or alternating a particular home screen icon—in embodiments referred to as the DIDA icon—on a mobile device are disclosed. One embodiment includes employing location technologies such as GPS or BLE (BLUETOOTH Low Emission) Beacons via the mobile platform, using portable devices including smart phones and tablets on any mobile operating system, to trigger changing the display of the DIDA icon to the icon of another mobile app, one specifically having high relevance to a user and their particular location. As is known, such mobile app dynamic icons are operatively connected to various mobile programs, either pre-existing on the device in use, or available for download and install, or a web page, via a particular mobile platform, so that any spatial change or movement by the phone and its user is also synchronized such that the home screen position where the DIDA icon is located, automatically initiates a type of automatic search for a mobile app, more relevant to locations within the changing proximity of the user. Our method—the service—will display that program's icon in the DIDA icon position. So while the DIDA application itself will have a graphical icon that identifies itself as a mobile application, the purpose of DIDA is to present links to other applications in the small space normally relegated to a single mobile app on the home screen of a device of a mobile operating system.

The process revises the concept of conventional search engines which allow a user to type in search criteria, press the “search” button and receive search results, modernizing and adapting the process for mobile computing devices. By the described methods, DIDA performs searches for mobile apps, automatically without touch, for the user. Certain mobile apps perform searches of places nearby while they are open on a user's screen. GPS and map apps often show restaurants, gas stations, hotels or other types of locations in connection with dynamically generated GPS maps. Other mobile applications use API's to display lists pf places nearby as users travel and change location. However, each of these mobile apps require specific user input. The function of DIDA is to automatically represent search results in the space usually afforded to a single fixed graphical ICON representing a single mobile app. Instead, the DIDA app changes icons continuously when a user travels from location to location. These icons are linked to the apps they represent.

Additionally, a unique identifier of the moving device is communicated to the service. Two way communication then occurs between the device and an app, via the service. As the device enters a predetermined proximity to a location such as a business location, within the network, it delivers the user's identifying information and calls the app the service deems most relevant that exists on the device and/or is available within the operating system. The service then places the icon of the relevant app or web page in the DIDA icon position so the user benefits from this method of automatic display. This method of dynamic proximity-based display of an app or web page icon is a form of automated search that optimizes space on a mobile device home screen and saves the user from unnecessary manual search. Over time, the service will store user information and deliver apps to the DIDA icon position based on proximity, user habits, user preferences and multiple other usage criteria.

Examples of specific apparatus and method for displaying this dynamically changing icon on the display of a mobile terminal are provided. One or more characteristics associated with the dynamic icon are compared to one or more context values, such as geographic area, time of day, seasonal conditions or user profile characteristics. Icons that best match one or more context values are represented as the icons animate and change on a single fixed icon position on the display device. The context values may include dynamically changing information, such as a current location of the user, so that as the user moves to a different geographic area, different app icons alternate in the fixed position on the display device.

On a mobile device, these icons generally correspond to mobile application programs, Web sites (aka “web apps”), and others. The icons displayed by DIDA can be retrieved from a cloud database and service that identifies a particular app, and its corresponding icon, as relating to a particular location. So this method is focused on the art of using sensors to confirm location of a user, then automatically searching to identify apps and their icons, for example registered in a cloud service. In the cloud service database these icons will have been associated with location based content. The described DIDA method dynamically retrieves and presents the associated app icon in the DIDA icon position, making it easier for the user to access and use a more relevant app to their location without having to search for that app on their various home screens or an “app store” provided by their particular device OS.

Essentially, the concept is; “Why search when you are already there?” When we consider the location based technologies and sensors available to confirm location, and the sophisticated methods of attributing behavior to action, it makes sense that mobile search should be fundamentally changed. From a desktop computer, we are essentially searching the world wide web to bring information back to us at our fixed location. But now just the opposite is true. In this age of mobility where mobile search outweighs desktop search, search is backwards. Search should be automatic and should be pre-filtered based on a user's location, preferences and condition. Users want to find locations, but it is also true that locations (businesses) need to find users, who are moving through geographical space, and so delivered content must be contextual to be more useful. So the presently described methods provide a system that makes both function and content dynamic to a context, such as location. In addition, we must move beyond touch, to intuition, allowing the algorithms to do the work for us, while optimizing space on the mobile device.

Modern apps need to adapt to serve the user without requiring extra steps that can easily be performed by modern databases. Nowhere is this concept more important than in the presentation of apps. There are just too many of them. The mobile screen is small and viewing conditions may be less than optimal while the user moving indoors and out.

The presently described methods and systems (referred to herein by the acronym DIDA) change this paradigm. If a user is at a department store in Seattle Wash., DIDA displays the department store app icon in the DIDA fixed position. When the user visits a local pub later that same day, the same icon position that formerly displayed the department store app icon, automatically transforms into the app icon for the pub. As the same user travels to a hotel at the end of the day, the same DIDA icon position that previously displayed the department store app icon, then the pub app icon, now displays the hotel icon. When this app is opened it launches not just the hotel chain app, but the hotel app configured for the particular address of the specific hotel at which the user is staying.

It is in this fashion that DIDA can display a nearly infinite amount of apps (more specifically, the ICONS that launch those particular apps) in the space of a single icon on one home screen of a user's mobile device.

The present disclosure therefore provides a method and a system for enabling varying the display of icons on a particular area of mobile device screen real estate, utilizing dynamic proximal variants and predictive algorithms analyzing user habits, within a communication network.

In embodiments, DIDA uses several components to achieve the described results: A) a cloud server connected to B) a database, C) location sensor technology like a BLE beacon or GPS, and D) the DIDA application installed on E) a user's (BLUETOOTH-enabled) mobile device which is connected to a service allowing WIFI, BLUETOOTH and/or data connectivity.

At a high level, mobile applications and their related icons are registered into a database. This could be the database of the app store for a particular operating system (OS). Or the app icons connected via links to the apps could be registered in a third party database. In this scenario we reference one particular business with a mobile app that has been registered into the database. However, it will be appreciated that this is merely one example, and other scenarios are contemplated. A user installs the DIDA application on their mobile computing device and enables BLUETOOTH. A BLE beacon is placed in a location, and a unique device identifier and unique major and minor identifiers are registered with the cloud database as a means of positively associating that location with its particular mobile application.

As the user approaches the location, the DIDA app on the user's mobile detects the beacon signal and unique identifiers. These identifiers are used to change the DIDA icon, converting it to display the app icon associated with that business location. The user taps the icon and the intended app is displayed for that location context.

In one aspect, the present disclosure describes a method for alternating the display of relevant icons on a portable communication device. When in use, a device and its user are moving spatially proximal to a business location that has a mobile app available on a particular operating system configured to operate through different operating systems installed in their hardware. The method includes using an application within the first device, to retrieve a unique coordinate corresponding to the location, and communicate the unique identifier to a service infrastructure. The service infrastructure allows detection of an app relevant to a particular business location. The device is connected to the service infrastructure to communicate operably with it, through the communication network. As the unique identifier is communicated, it is stored by a service infrastructure, within its database.

Furthermore, the device is operably connected to the service infrastructure, and is capable of identifying/detecting locations devices in its proximity, through the service infrastructure. Eventually, the device detects any business location spatially proximal to it, and within the particular operating system, it locates an app, related to that business, the service infrastructure checks and confirms whether or not the app is already installed on the user's device. If the app is already installed, the icon is displayed as “ready to launch.” If the app is available on the operating system, but not yet installed, the icon is displayed as “ready to install.” Furthermore, to conserve drive storage space on a particular device it is anticipated that a cloud based operation might be invoked or an option to temporarily install a particular app will be offered as an option.

In another aspect, service settings—based on the large number of apps and the limited hard drive space required to operate them—allow the user to automatically manage the storage space on a particular mobile device. Using the techniques described above relating to analysis of habits, frequency of use and other relevant personalization criteria, automatic optimization of which apps are launched on a temporary basis and which apps are stored more permanently on a user's mobile device memory is achieved. Practically speaking, the dynamic display of a particular app icon, and the opportunity to install it, may be triggered by a visit to a business, and later, that app could be automatically uninstalled based on predetermined space management needs, location, frequency of visits, or other criteria. For example: a woman who lives in Seattle visits Houston where an app is installed during travel. Algorithms such as Bayesian inference determine that she rarely visits Houston and mobile device storage space is limited, therefore, at the user's election, the app is installed and operates while she is in Houston, but is later uninstalled as she arrives at the airport and leaves the area.

To enable this, a user would confirm storage limits on their device preferences screen. One setting might restrict additional content or application storage if the user's available storage drops below a certain number of megabytes or a percentage of total storage.

The DIDA application would employ business rules within the cloud server and database to prioritize the storage it utilizes and stay within the requirements set by the database rules. The same proximity architecture that enable the changing of icons can be used to determine when a user is proximal to a location. The storage of content and functions can be permanent or temporary. DIDA would add a rule-based method for tying this to apps as they are downloaded, installed and launched.

Once storage limits are reached an older, less utilized app or content internal to the mobile device, would need to be pushed back into the cloud to make room for the new app initiated by the user.

In yet another aspect, the present embodiment provides a system for setting up multiple dynamic icons on a device, each dynamic icon operating based on a category selected or specified by the user through different operating systems, and working on proximity data and other personalization criteria. For example, one dynamic icon could be set to display restaurant apps or websites and another dynamic icon could be set to display entertainment apps or websites, while a third dynamic icon might be set to display deals and rewards. These deals and rewards could lead the user to the apps or websites in which they are contained or delivered directly via the service interface.

The presently described methods and systems substantially eliminate the problems of lack of display space and limited storage space, on different communication devices, including smart phones, operating through different operating systems, and uses, personalization and spatial movement and proximity technologies between such devices, and a service, to rotate the display of the most relevant icons to a specific location on a designated space on the user's home screen. In that context, it will be appreciated that the terms “icon,” “dynamic icon,” “app” and “dynamic app” also refer to web pages or any delivery method of delivering content related to a business, place or event, at a particular location. Thus another aspect of the present disclosure will be database connections to apps, web pages or other repositories of the information deemed to be relevant to the user and intended to be displayed via the methods described herein.

The method in accordance with the present disclosure is implementable on, and is compatible with, any portable communication device that supports wireless communication such as BLUETOOTH or WLAN technology, and is in operable connection with wireless communication networks, or BLUETOOTH stations, WLAN stations etc. Furthermore, the disclosure is not limited merely to only smart phones, but works equally well with other portable communication devices/mobile computing devices as summarized above.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 illustrates a determination of distance detection for a mobile computing device using BLUETOOTH Low Energy (BLE) beacons;

FIG. 2 illustrates a system for providing a dynamic icon on a mobile computing device according to proximity to a content provider according to the present disclosure;

FIG. 3 illustrates in flow chart form a system according to the present disclosure for providing a dynamic icon on a mobile computing device according to proximity to a content provider and relevance to a user;

FIG. 4 illustrates the system for providing a dynamic icon on a mobile computing device by a push notification according to proximity to a specific content provider (a retail store) as shown in FIG. 2;

FIG. 5 illustrates an embodiment for establishing a secure connection between a push notification service according to FIG. 2 and a mobile computing device;

FIG. 6 illustrates a system according to the present disclosure for revising contextual information provided as a dynamic icon for various areas within a content provider location as a user travels through the content provider location; and

FIG. 7 illustrates a representative architecture for the system of the present disclosure.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention.

Preliminarily, certain technologies utilized in the present methods and systems merit discussion. Many service discovery protocols are available in the mobile communication technology, which allow mobile devices to detect a user's location and to connect that user to businesses or other sites of interest located in their proximity. Global Positioning Satellite (GPS) technology has long been included in smart phone technology and works reliably outdoors. But tall buildings and other obstructions make triangulation difficult. And GPS has even less usefulness indoors. Recently, BLUETOOTH Beacons, which enable devices to accurately triangulate locations with pinpoint accuracy, have achieved more widespread use.

Portable communication devices, including mobile devices, cellular phones, smartphones, personal laptop computers, personal digital assistants (PDA), etc. are predominantly used in the art, for communication and other purposes, and such devices are often equipped with the feature of supporting wireless communication, including the Wireless Local Area Networks (WLAN) and BLUETOOTH technology etc., through suitable applications/modules installed within the devices. BLUETOOTH technology facilitates short range wireless communication between such devices. Using short wavelength radio transmission, the BLUETOOTH technology enables voice and data exchange between the devices and between the devices and BLE Beacons. To support the Blue-tooth technology, the communication devices, including mobile devices, generally have a Radio Frequency Blue-tooth Transceiver that lies at their physical layer, and an adapter which may be in-built, or can be in the form of a card that connects to the device.

BLUETOOTH is a wireless technology standard for exchanging data over short distances (using short-wavelength radio waves in the ISM (Industrial, Scientific, Medical) band from 2.4 to 2.485 GHz) from fixed and mobile devices, building personal area networks (PANs). BLUETOOTH is managed by the BLUETOOTH Special Interest Group aka, “the SIG”), which has more than 19,000 member companies in the areas of telecommunication, computing, networking, and consumer electronics. BLUETOOTH was standardized as IEEE 802.15.1, but the standard is no longer maintained. The SIG oversees the development of the spec for BLUETOOTH and BLE (BLUETOOTH Low Energy), manages the qualification program, and protects the trademarks. To be marketed as a BLUETOOTH device, it must be qualified to standards defined by the SIG.

BLUETOOTH low energy (BLE) is a wireless area network technology designed and marketed by the nonprofit, nonstock corporation BLUETOOTH Special Interest Group aimed at novel applications in the healthcare, fitness, security, and home entertainment industries. Compared to “Classic” BLUETOOTH, BLE is intended to provide considerably reduced power consumption and cost while maintaining a similar broadcast range of about 20 meters. BLE was merged into the main BLUETOOTH standard in 2010 with the adoption of the BLUETOOTH Core Specification Version 4.0. Many modern mobile operating systems natively support BLE. The BLUETOOTH SIG predicts more than 90 percent of BLUETOOTH-enabled smartphones will support the low energy standard by 2018.

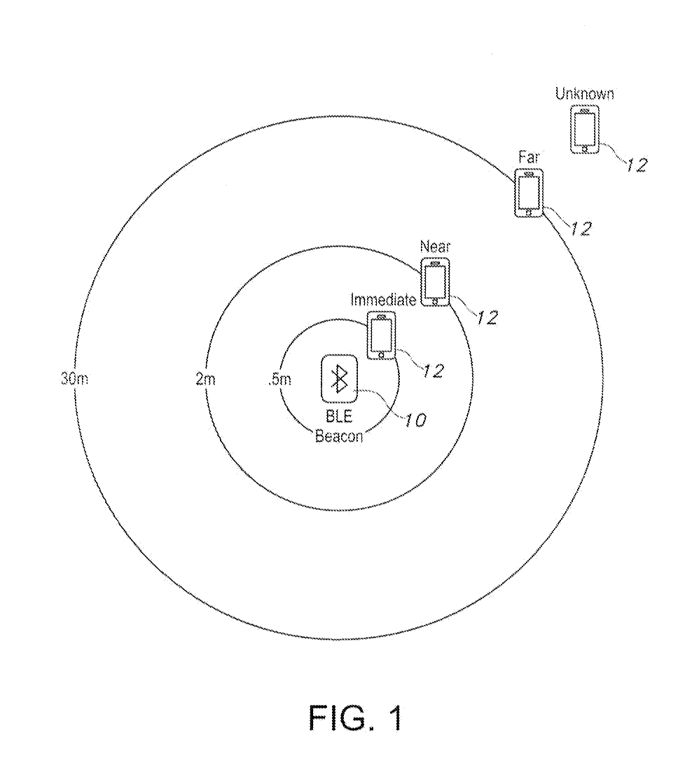

In a BLE Beacon system, Received Signal Strength Indication (RSSI) is the relative received signal strength in a wireless environment, in arbitrary units. RSSI is an indication of the power level being received by the antenna. Therefore, the higher the RSSI number, the stronger the signal. To date, all BLE beacons are omnidirectional (broadcasting in a 360 degree pattern) in nature and the primary method used to make BLE beacons commercially useful is the RSSI method. In general, the greater the distance between the device and the beacon, the lesser the strength of the received signal. This is illustrated in FIG. 1, showing a BLE beacon 10 determining various proximity indices (“immediate,” “near,” “far,” “unknown”) according to a detected distance from a BLUETOOTH-equipped smartphone 12.

This inverse relation between the distance and RSSI is used to estimate the approximate distance between the device and the beacon using another value generally referred to as Measured Power. Measured Power is a factory-calibrated, read-only constant which indicates the expected RSSI at a distance of 1 meter to the beacon. Combined with RSSI, this allows a method of estimating the actual distance between the device and the beacon.

Note that, due to external factors which influence the BLUETOOTH radio wave broadcasted by beacons—such as absorption, interference or diffraction—the RSSI value tends to fluctuate. The further away the device is from the beacon, the more unstable the RSSI readings will be. And, since distance approximation is based on RSSI, this directly translates to less accurate estimates at greater distances. By this method, when a sending device and a receiving device (such as a smartphone carried by a user) are within range of each other distance can be determined with some degree of accuracy.

Broadcasting Power is the power with which the beacon broadcasts its signal, i.e. the power with which the signal leaves the beacon's antenna. These Broadcast Power settings can be varied. The value ranges between −30 dBm and +4 dBm, lowest to highest power settings respectively. The higher the power, the bigger the beacon's range and the more stable the signal, but if the beacon is battery powered, high power may shorten the battery life.

Due to constraints imposed by original equipment manufacturers, there is typically an incompatibility factor between the different mobile device operating systems, which obstructs these communication devices from detecting each other, when mutually coupled in a network. For example, a smartphone running a proprietary operating system of a first manufacturer can only detect another smartphone of that manufacturer, and no other device, within its near-field wireless communication network. A smartphone running a proprietary operating system of a different manufacturer will not be detected.

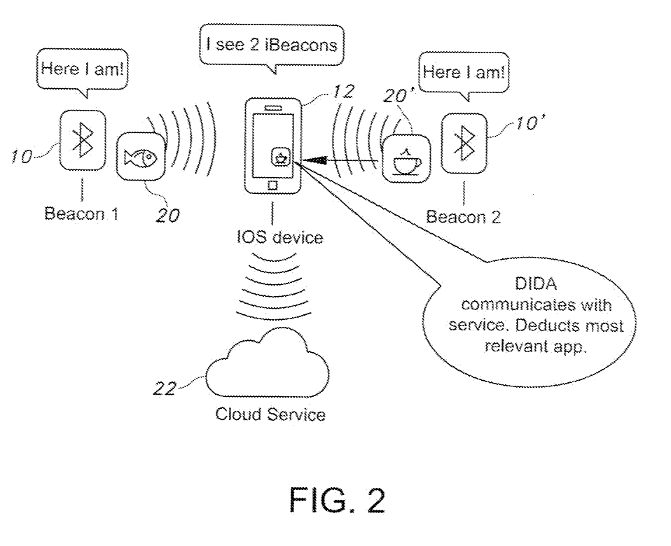

With reference to FIG. 2, the mobile device 10 is situated between and in range of 2 different BLE beacons 10, 10′. As will be described, the presently described methods and systems apply rules based on movement, signal strength and other factors to determine which icon 20, 20′ is most relevant to the user and so which to display. The selected icon is operatively connected to an application, web page, service, etc. of relevance to the user based on the applied rules. The application, web page, service, etc. may be hosted on a remote computing system which may be maintained in a cloud computing environment, depicted nebulously in FIG. 2 as cloud service 22.

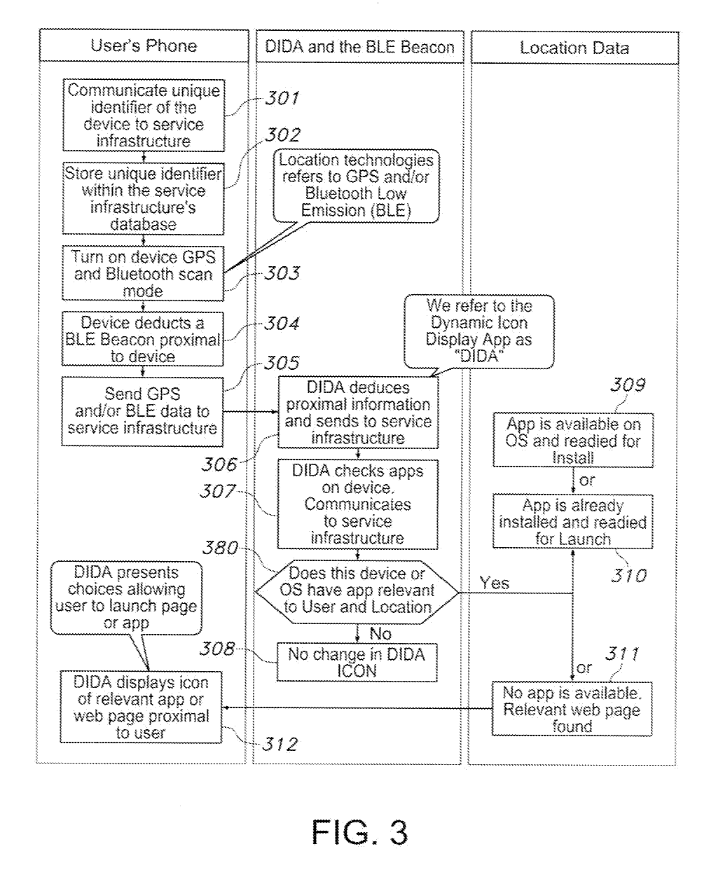

FIG. 3 depicts in flow chart form an embodiment of a method according to the present disclosure for providing a dynamic icon for a mobile computing device, including portable communications devices such as smartphones. The steps are depicted in an order, but it will be appreciated that the order of the steps is presented for purposes of example only, and that various steps of the method may be performed in a different order, concurrently, etc.

At step 301, a unique identifier of the mobile computing device is transmitted to a service infrastructure, for example an application server hosted in a cloud computing environment. That unique identifier may be stored (step 302) in a database of the service infrastructure for current and/or future use. At step 303, a location identifier of the mobile computing device is activated, for example GPS, BLUETOOTH scanning, etc. at step 304, as a user of the mobile computing device traverses through various geographical locations, the mobile computing device detects a BLE beacon proximate to the device. At step 305, the mobile computing device transmits GPS and/or BLE data to the service infrastructure.

At step 306, the DIDA application deduces proximity information of the mobile computing device to the BLE beacon, and transmits same to the service infrastructure. At step 307, a determination is made by the DIDA application of the presence, or not, of an app most relevant to the mobile computing device location and/or to the user. Relevance to the user is made by employing various algorithms for quantifying user preferences and user habits, as described supra and as known in the art. When certain mobile apps are registered into various mobile operating systems they fall into different categories or types. And some apps have little relevance to a particular geographic location. For example, popular game apps do not bear a high relevance to a particular street address. However, the app for a particular restaurant on Fifth Avenue in New York City has a very high degree of relevance to a user's physical location. So as we catalogue and sort all the apps available on a particular mobile operating system the DIDA database will organize apps giving priority to the ones determined to having a high degree of relevance to physical location.

In that regard, GPS apps, restaurant apps and various travel apps perform similar methods of sorting and delivering information to users looking for places to visit on vacation or places to eat when walking or driving through areas. These apps often display this information on screens internal to the app itself. The difference with our method is when the DIDA service locates an app relevant to a location it displays the ICON of that app as a search result in the app icon space. Another difference between the DIDA method and certain other methods of generating and displaying search results is the use of BLE beacons and other location sensors to determine precise location. The advent of bluetooth devices has provided a new method of micro location context, by employing the signal strength method of determining distance mobile applications can perform location based services and deliver contextual content indoors and out; places where GPS is ineffective or where greater location accuracy is needed.

However, it will be appreciated that DIDA can use other methods of determining location by using other sensors like RFID tags, photo matching, sound wave reception, UF signals from routers or other broadcast devices. The principle employed with DIDA is to use any and all practical methods available to precisely determine a user's location, then to compare that information to a database of apps catalogued and sorted as having a high degree of relevance to a user's location, then, to deliver the most relevant app to the DIDA icon for display to the user. Since an APP icon is relatively small and DIDA will only be able to display a single icon at a given moment, the question of how to determine the highest degree of relevance is important. Thus, in addition to user location, the presently disclosed methods and systems also rely on predetermined user criteria established by predictive algorithms. To sort through the options and deliver the best results, machine-learning, predictive algorithms are employed such as Bayes theorem, which, stated mathematically, is;

$$P ( A \vert B ) = \frac{P ( B \vert A ) P ( A )}{P ( B )} .$$

Here A and B are events,
P(A) and P(B) are the probabilities of A and B, and
P(A|B), the conditional probability, is the probability of A given that B is true.

For DIDA to be effective in adding user behavioral data in determining which app icon to select and display we first need to identify probabilistic relationships of business locations visited behavior, and especially to understand the probabilistic relationship between business types visited and time of day and related factors. Several analytical methods may be utilized in achieving a more targeted result. In particular embodiments, the algorithms are based on Bayesian Networks; 1) Visual analysis of Bayesian Networks to find initially interesting patterns, variables and their relationships, 2) user segmentation analysis, 3) node force analysis and 4) a combination of expert-based service clustering and machine learning for usage diversity vs. intensity analysis. All the analyses will involve handset—based data collected from the DIDA app. The accuracy of our predictions increases when the number of users increases and as each user increases the frequency of use of the app. In addition, probabilistic relationships can be found within certain business types cluster pairs in their diversity and intensity values. Based on these relationships, similar mediation type of behavior can be found for the kinds of places a person visits as and when and where this happens. As is known, a Bayesian Network is a straightforward way to express model data on a high level. Moreover, Node Force, Direct and Total effect are useful metrics to measure the mediation effects. The clustering implemented as a hybrid of machine learning and expert-based clustering process is also a useful way to calculate relationships between clusters of more than a hundred individual users.

Handset-based measurements are a data collection method utilizing smartphones' ability to respond to the DIDA application software. These measurements are implemented by installing a data collection application to the mobile phones of opt-in participants and by collecting data in the cloud. With these measurements rich contextual user level data on business locations visited can be collected. Handset-based measurements have increasingly been used for a number of purposes in the recent years, applications ranging from sociology to consumer behavior. Business locations visited in particular will be an important data set.

Bayesian Networks (BN) method can be used for analyzing handset-based data from a holistic business locations visited perspective. This method may use BN to find business types and to cluster locations, using handset-based measurement data and GPS/Bluetooth low energy sensors. BN is an analytical method that we can use for inferential analysis, e.g., to make “what if” simulations, to predict behavior patterns and future trends, to understand why something most probably happened, and to understand which data correlate with other data. It is challenging to analyze the relationships between business locations visited patterns as the number of possible places to visit is very high in the used dataset. Although a BN procedure will offer easier methods to study this data the results could be further qualified against other methods like Regression analysis or Neural Networks.

As Bayesian Networks (also called Bayes Belief Networks (BBN)). A BN can be created in three ways, namely manually by using expert knowledge, by using machine learning, or a combination of them. As said, a BN is used for inferential analysis (often called predictive analytics), e.g., to predict behavior patterns and future trends, to make “what if” simulations, to understand why something most probably happened and to understand which data correlate with other data. In the present disclosure, user behavioral data analyzed by a Bayesian network in combination with ascertained location data—either stored in the cloud or in memory in the mobile device—allows a precise determination of which app icon to display in the DIDA app at a particular time for a particular user.

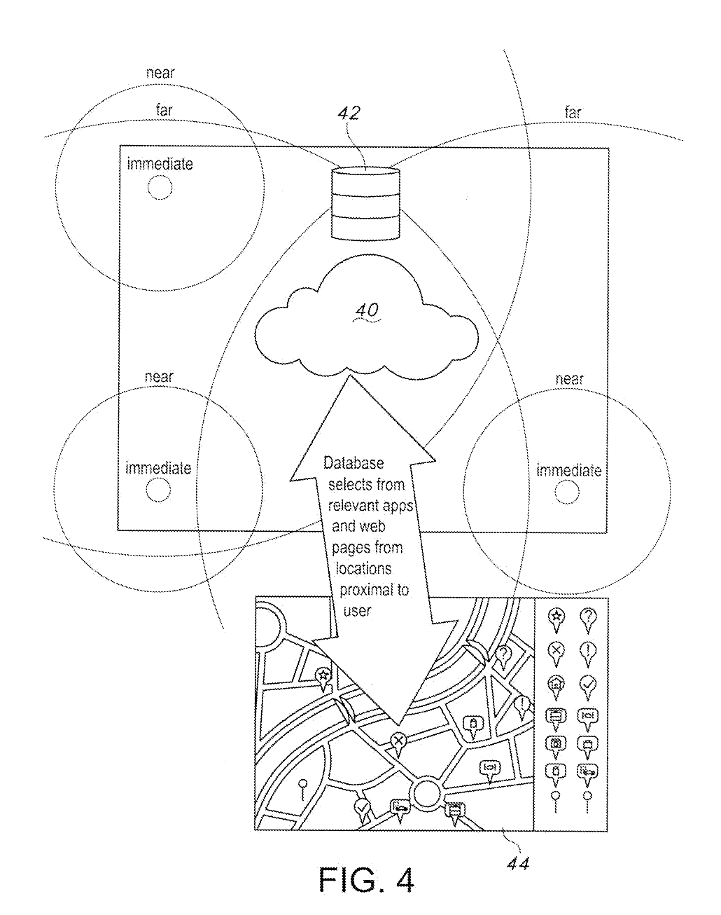

If no app is available relevant to the user and user location, there is no change in the DIDA icon (step 308). If an app is available that is relevant to the user and user location, the DIDA application queries to determine whether the app is currently available on the mobile computing device OS for installation (step 309) or whether the app has already been installed on the mobile computing device and is ready to launch (step 310). Alternatively, no app may be available but a most relevant web page may be (step 311). This is depicted schematically in FIG. 4, showing various determinations of proximity for mobile computing devices (not shown in this figure), a service infrastructure such as an application server hosted in a cloud computing environment (nebulously, ref. num. 40) and/or a third party app store 42 from which apps and/or web pages may be retrieved according to measures of relevance including proximity (“immediate,” “near,” etc.) and user-based criteria. As yet another embodiment, the icons may be displayed on a map graphic 44 indicating locations proximal to the mobile computing device position.

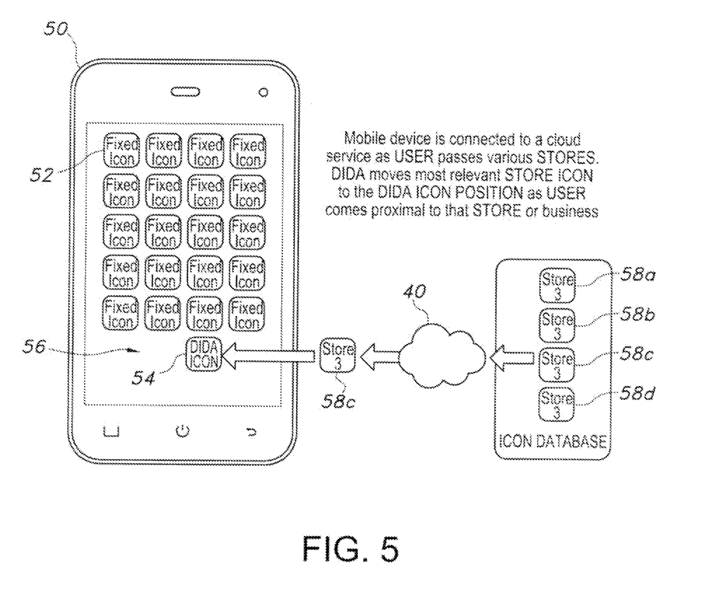

In these scenarios, the DIDA application automatically reconfigures the DIDA icon to display a dynamic icon operatively linked to the app or web page found to be most relevant according to user location and user criteria (FIG. 3, step 312). This is graphically represented in FIG. 5, showing a mobile computing device 50 (in the depicted example being a smartphone) including multiple fixed icons 52 and also a DIDA icon 54 typically displayed in a particular location on a display screen 56. In the depicted example of FIG. 5, a user is passing through multiple retail stores, depicted as icons 58a, 58b, 58c, and 58d. From the foregoing analyses, it is determined based on mobile computing device 50 proximity and user-based criteria that icon 58c represents the most relevant icon, and that icon operatively linked to content provided by that store (which may be an app, a web page, etc.) is retrieved and displayed in place of DIDA icon 54.

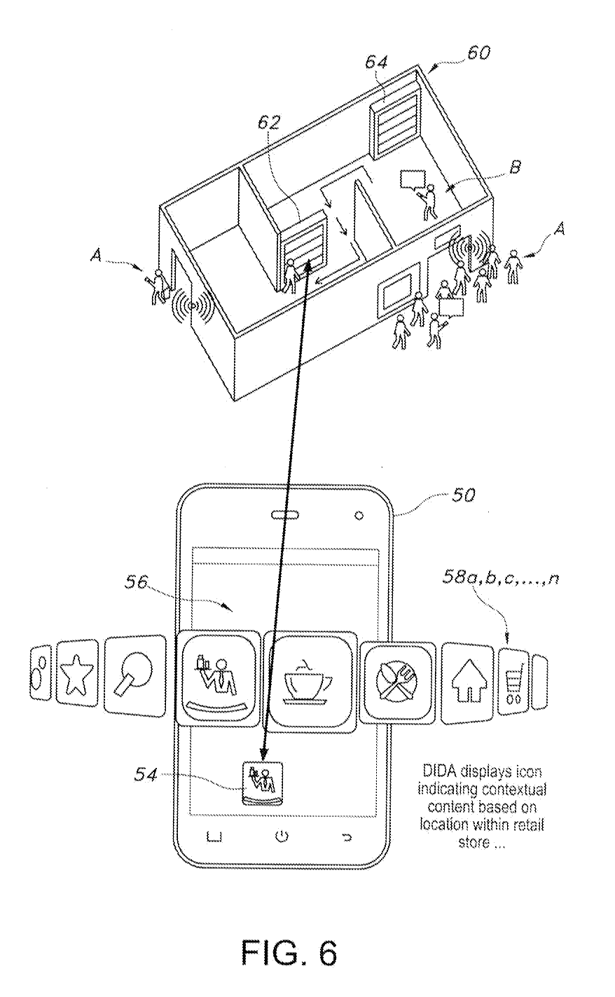

It will be appreciated that by using the precise location determination technologies described supra, the present methods are not restricted to different locales but may be used to provide most relevant content within a locale. For example, as shown in FIG. 6, a user may be passing through a particular business 60, which may include different areas shown generically as location 62 and location 64 within business 60 (for example, a retail store including a cosmetics counter 62 and a magazine counter 64). By proximity detection, it is determined that the mobile computing device is near but not in an interior of the business 60 (arrow A), and so the most relevant content sent to the mobile computing device 50 is a web page or other advertisement of the business 60. On the other hand, a user may have entered the business 60 (arrow B), and so the most relevant content sent to the mobile computing device 50 is one or more coupons for services or goods provided by business 60. Still further, the provided coupons may be tailored to predetermined user preferences as described above, for example coupons relevant to goods displayed at location 62 and/or location 64 within business 60 as the mobile computing device 50 passes those locations. That relevant information is displayed as a series of changing dynamic icons 54 on a display screen 56 of mobile computing device 50, by displaying the most relevant of icons 58a . . . 58n as the user passes through the business 60.

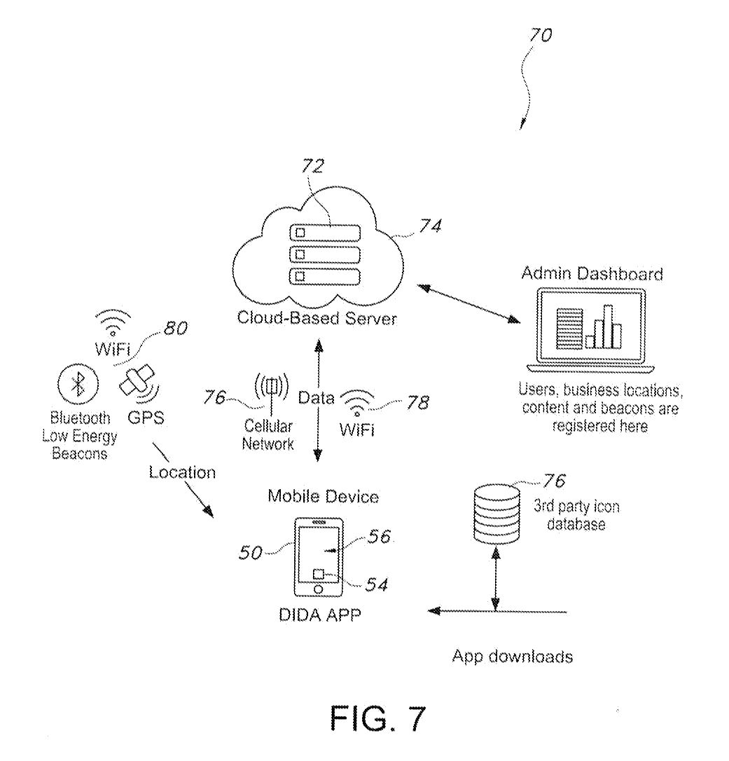

FIG. 7 depicts a representative architecture 70 for a system for accomplishing the described method according to this disclosure. A mobile computing device 50 includes a DIDA icon 54 displayed on a fixed position in a display screen 56. Mobile computing device 50 communicates with a service infrastructure which may include, among other elements, an application server 72 hosted in a cloud computing environment 74 and an app store 76 maintained by a third party.

In this regard, the mobile computing device 50 typically uses wireless connections to other devices/networks such as over a cellular network 76 and/or a wi-fi network 78, which may be direct or indirect connections. Other devices within the described system may use wired, wireless or combined connections to other devices/networks and may be direct or indirect connections. If direct, they typify connections within physical or network proximity (e.g., intranet). If indirect, they typify connections such as those found with the internet, satellites, radio transmissions, or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

As described above, the mobile computing device 50 is configured with or adapted to cooperate with one or more modules 80 providing indicators of geographical location of the device 50, including wi-fi, GPS, BLUETOOTH, BLE beacons, and others. An administrative functionality 82 may be included, for example to register specific users of mobile computing device 50, to register particular business locations, to register particular BLE beacons, etc.

As a result, the foregoing scheme ensures that the user always receives the most relevant content according to mobile computing device 50 location, i.e. proximity to a particular content provider, and also according to predetermined user preferences. Furthermore, the protocol ensures that the most relevant content is displayed at a single location within a display screen 56 of a mobile computing device 50, but evolves as the user alters the geographical location of the mobile computing device 50 (and so alters what is the most relevant content to be made accessible via the icon 54).

In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

The disclosed embodiments may also include software and computer programs embodying the process steps and instructions described above. In one embodiment, the programs incorporating the process described herein can be stored as part of a computer program product and executed in one or more computers in one or more of the devices or systems. The computers can each include computer readable program code means stored on a non-transitory computer readable storage medium for carrying out and executing the process steps described herein. In one embodiment, the computer readable program code is stored in a memory. In one embodiment, one or more of the devices and systems include or are comprised of machine-readable instructions that are executable by a processor of a computing device.

The systems and devices shown in the embodiments disclosed herein are configured to utilize program storage devices embodying machine-readable program source code that is adapted to cause the devices to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read only-memory (“ROM”) floppy disks and semiconductor materials and chips.

The systems and devices may also include one or more processors or processor devices for executing stored programs, and may include a data storage or memory device on its program storage device for the storage of information and data. The computer program or software incorporating the processes and method steps incorporating aspects of the disclosed embodiments may be stored in one or more computer systems or on an otherwise conventional program storage device. For example, in one embodiment, the devices and systems, can include one or more controllers that are comprised of, or include, machine-readable instructions that are executable by a processing device. The method and the system of the present disclosure can be used for various purposes, including, though not limited to, plain device discovery, facilitating multiplayer online gaming between users of different communication devices operating through different incompatible operating systems which are generally incompatible, or to exchange data or enable short range communication between such devices.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of the other figures.

1. In a computing system network environment, a method for displaying information on a display screen of a mobile computing device, comprising:
providing a mobile computing device having at least one processor and at least one memory;
communicating a unique identifier of the mobile computing device to a remote computing system comprising one or more computing devices each having at least one processor and at least one memory, the remote computing system being configured to detect at least a first proximity of the mobile computing device to a first geographical location;
by the remote computing system, determining a most relevant content according to said unique identifier and said detected proximity;
by the remote computing system, transmitting a first icon operatively connected to the determined most relevant content to the mobile computing device; and
automatically displaying the first icon on a predetermined position of a display screen of the mobile computing device.

2. The method of claim 1, further including by the remote computing system determining a second proximity of the mobile computing device to a second geographical location and determining a succeeding most relevant content according to said unique identifier and said second proximity, transmitting a second icon operatively connected to the succeeding most relevant content, and replacing the first icon with the second icon on the predetermined position of the display screen.

3. The method of claim 1, wherein the unique identifier is selected from the group consisting of an identifier assigned to a Network Interface Controller (NIC) of the mobile computing device, a Media Access Control (MAC) identifier of the mobile computing device, user registration information, and combinations thereof.

4. The method of claim 1, further including, by the remote computing system, storing the unique identifier in a database.

5. The method of claim 4, further including, by the remote computing system, matching the unique identifier to another identifier stored in the database.

6. The method of claim 1, wherein the most relevant content is retrieved from the mobile computing device memory.

7. The method of claim 1, wherein the most relevant content is retrieved from a database hosted by the remote computing device.

8. The method of claim 7, wherein the most relevant content is delivered in a format compatible with a determined operating system of the mobile computing device according to the unique identifier.

9. The method of claim 8, further including discarding from the memory of the mobile computing device the most relevant content after a step of accessing by a user, the discarding being determined according to a criteria selected from one or more of user frequency of use of the most relevant content and frequency of user visitation of the determined geographical location.

10. The method of claim 1, wherein the mobile computing device proximity is determined by one or both of a module of the mobile computing device configured for determining a geographical location by global positioning satellite (GPS) technology and module of the mobile computing device configured for determining a Relative Received Signal Strength (RSSI) of a BLUETOOTH Low Energy (BLE) beacon.

11. The method of claim 1, wherein the remote computing system comprises one or more of a server hosted in a cloud computing environment, one or more computing devices hosting an app database; one or more administrative computing devices hosting an administrative database, a router or network wi-fi transmitter, and combinations thereof.

12. The method of claim 1, further including determining the most relevant content according to said unique identifier, said detected proximity, and one or more predetermined user criteria.

13. A computing system for displaying information on a display screen of a mobile computing device, comprising:
a mobile computing device having at least one processor and one memory and a display screen and configured for communicating a unique identifier of the mobile computing device to a remote computing system;
wherein the remote computing system is configured to detect at least a first proximity of the mobile computing device to a first geographical location and to determine a first most relevant content according to said unique identifier and said detected first proximity; and
further wherein the mobile computing device is further configured to display a first icon operatively connected to the first most relevant content on a predetermined position of the display screen.

14. The system of claim 13, further wherein the remote computing system is configured for determining a next proximity of the mobile computing device to a next geographical location and for determining a next most relevant content according to the unique identifier and the next determined proximity.

15. The system of claim 14, further wherein the remote computing system is configured for transmitting a second icon operatively connected to the next most relevant content.

16. The system of claim 15, wherein the mobile computing device is further configured for replacing the first icon with the second icon on the predetermined position of the display screen.

17. The system of claim 13, wherein the mobile computing device includes one or more modules for determining proximity by one or both of a global positioning satellite (GPS) technology and a Relative Received Signal Strength (RSSI) of a BLUETOOTH Low Energy (BLE) beacon.

18. The system of claim 13, wherein the remote computing system comprises one or more of a server hosted in a cloud computing environment, one or more computing devices hosting an app database; one or more administrative computing devices hosting an administrative database, a router or network wi-fi transmitter, and combinations thereof.

17. A computer program product available on a non-transitory computer readable medium for loading on a computing device in a computing system environment, the computer program product being configured for displaying a most relevant content on a display screen of a mobile computing device, comprising:
executable instructions for communicating a unique identifier of the mobile computing device to a remote computing system;
executable instructions for communicating to the remote computing system a first proximity of the mobile computing device to a first geographical location; and
executable instructions for displaying a first icon operatively linked to a most relevant content on a predetermined position of the display screen, the first icon being selected by the remote computing system according to said unique identifier and said first proximity.

18. The computer program product of claim 17, further including executable instructions for communicating to the remote computing system a next proximity of the mobile computing device to a next geographical location; and
executable instructions for replacing the first icon on the predetermined position of the display screen with a second icon operatively linked to a next most relevant content, the second icon being selected by the remote computing system according to said unique identifier and said next proximity.
